(19) United States
(12) Patent Application Publication
(10) Pub. No.: US 2021/0334535 A1
(43) Pub. Date: Oct. 28, 2021

(54) SYSTEMS AND METHODS FOR DYNAMIC CONTENT ARRANGEMENT OF OBJECTS AND STYLE IN MERCHANDISING

(71) Applicant: AT&T Intellectual Property I, L.P., Atlanta, GA (US)

(72) Inventors: Donald Perciful, Round Rock, TX (US); Yupeng Jia, Austin, TX (US); Miranda Huet, Austin, TX (US); James Pratt, ROUND ROCK, TX (US); Eric Zavesky, Austin, TX (US); Michael Gonzales, Austin, TX (US)

(73) Assignee: AT&T Intellectual Property I, L.P., Atlanta, GA (US)

(21) Appl. No.: 16/859,704

(22) Filed: Apr. 27, 2020

(51) Int. Cl. G06K 9/00; G06T 7/73; G06Q 30/02; G06Q 30/06

(52) U.S. Cl. CPC G06K 9/00671; G06Q 30/0641; G06Q 30/0275; G06T 7/75

(57) ABSTRACT

Aspects of the subject disclosure may include, for example, obtaining a first image, the first image comprising a depiction of a first product of a first potential advertiser; analyzing the first image to determine a first spatial placement of the first product, the first spatial placement being relative to another object in the first image; receiving, from user equipment, a user image that shows a depiction of a user environment; analyzing the user image, the analyzing resulting in a plurality of identified objects; determining whether the another object corresponds to a corresponding one of the plurality of identified objects; responsive to a determination that the another object corresponds to the corresponding one of the plurality of identified objects, generating information that places the depiction of the first product in the depiction of the user environment; and responsive to the generating, transmitting the information to the user equipment. Other embodiments are disclosed.

### FIELD OF THE DISCLOSURE

The subject disclosure relates to systems and methods for dynamic content arrangement of objects and style in merchandising.

### BACKGROUND

Online purchases are sometimes visualized by augmented reality (“AR”) applications or from an image sample provided by a user. However, items that are suggested to the user for purchase may not be an appropriate fit for the user's style, preferences, available space, etc.

Additionally, advertisers (for simulated product placements to such online users) typically have no way of specifying restrictions or affinity for certain environments.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system that can function (fully or partially) within the communication network of FIG. 1 in accordance with various aspects described herein.

FIG. 2B is a block diagram illustrating an example, non-limiting embodiment of a system that can function (fully or partially) within the communication network of FIG. 1 in accordance with various aspects described herein.

FIG. 2C depicts an illustrative embodiment of a method in accordance with various aspects described herein.

FIG. 2D depicts an illustrative embodiment of a method in accordance with various aspects described herein.

FIG. 2E depicts an illustrative embodiment of a method in accordance with various aspects described herein.

FIGS. 2F-2J depict example, non-limiting embodiments showing illustrations of placement of objects in images of a room in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for merchandising, product selection, location selection for image placement, and/or advertiser selection. Other embodiments are described in the subject disclosure.

One or more aspects of the subject disclosure include a model that allows for modularity around customizing visual displays to best meet a customer's marketing preferences.

One or more aspects of the subject disclosure include learning where to place objects (such as simulated product placements) based on information in a catalog (e.g., an electronic catalog of one or more advertiser products) and/or based on user image(s). The learning can be used, for example, to make suggestion(s) and/or recommendation(s) and/or advertisement placement(s). In one example, the leaning can be carried out via inference, from one or more scenes from an advertiser, as to where specific objects may be placed by category (e.g., kitchen, dining, etc.) and/or specific instance (e.g., chair). In addition (or in the alternative) the leaning can be carried out via inference, from one or more images from a user, as to where specific objects may be placed by category (e.g., kitchen, dining, etc.) and/or specific instance (e.g., chair).

One or more aspects of the subject disclosure include identification and/or content adjustment by user preference(s) for different styles. In one example, user preference(s) can be discovered by determination of similar items found in one or more images from a user. In another example, user preference(s) can be specified such as by identification of certain items found in image. In another example, one or more user preferences can be pulled (obtained) from a database. In another example, suggestion(s) and/or recommendation(s) and/or advertisement placement(s) can be based on image similarity and/or based on one or more other features (e.g., dimensions, type of object, age of manufacture, etc.).

One or more aspects of the subject disclosure include mechanisms that facilitate “spatial ad words” for advertisers—wherein such spatial ad words can specify where an advertisement can be located by providing its physical context. For example: (a) place poster of advertiser “A” near other sports or Broadway objects; (b) place large dresser configuration of advertiser “B” only in houses that have a minimum amount of open space. In one example, advertisers can bid for ranking among these spatial ad words (such as to be executed by the placement/recommendation described herein).

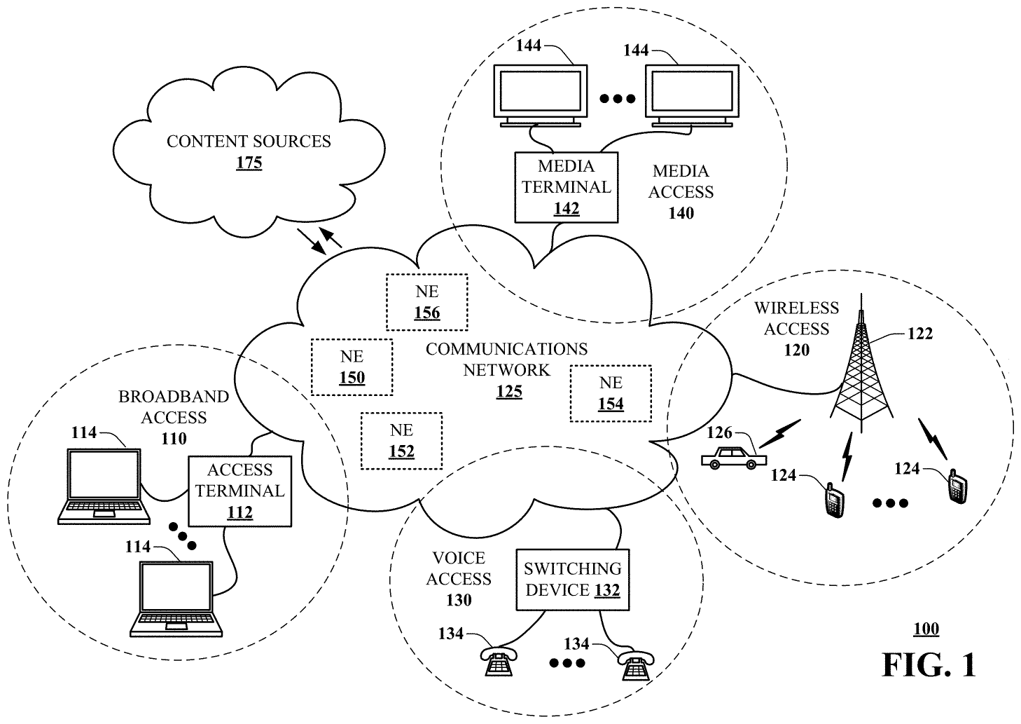

Referring now to FIG. 1, a block diagram is shown illustrating an example, non-limiting embodiment of a communication network 100 in accordance with various aspects described herein. For example, communication network 100 can facilitate in whole or in part merchandising, product selection, location selection for image placement, and/or advertiser selection as described herein. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

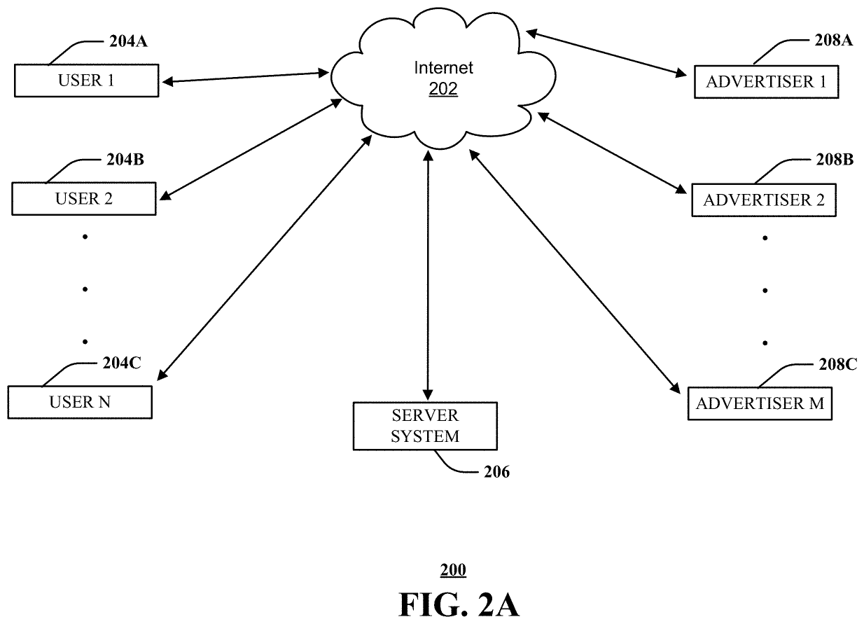

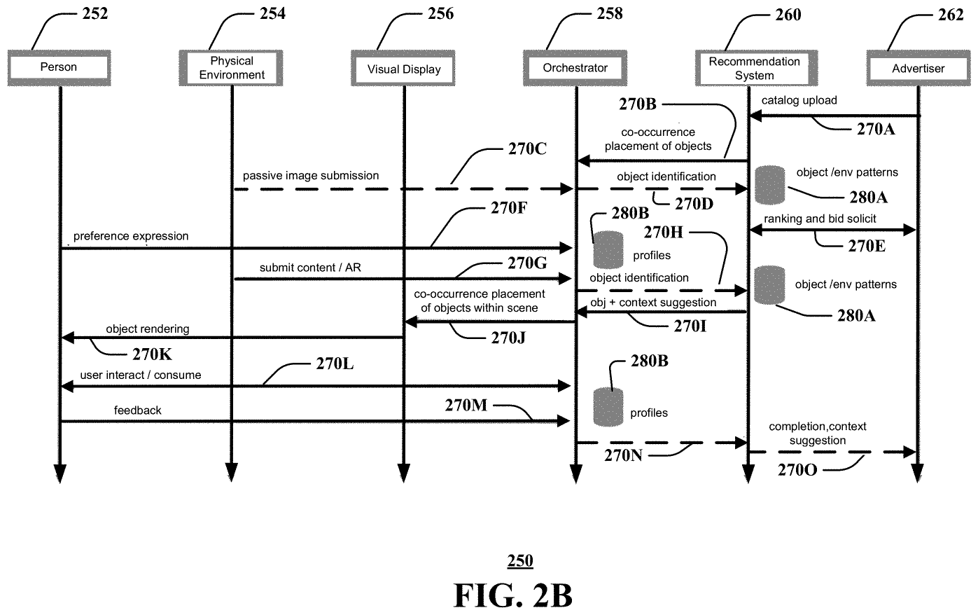

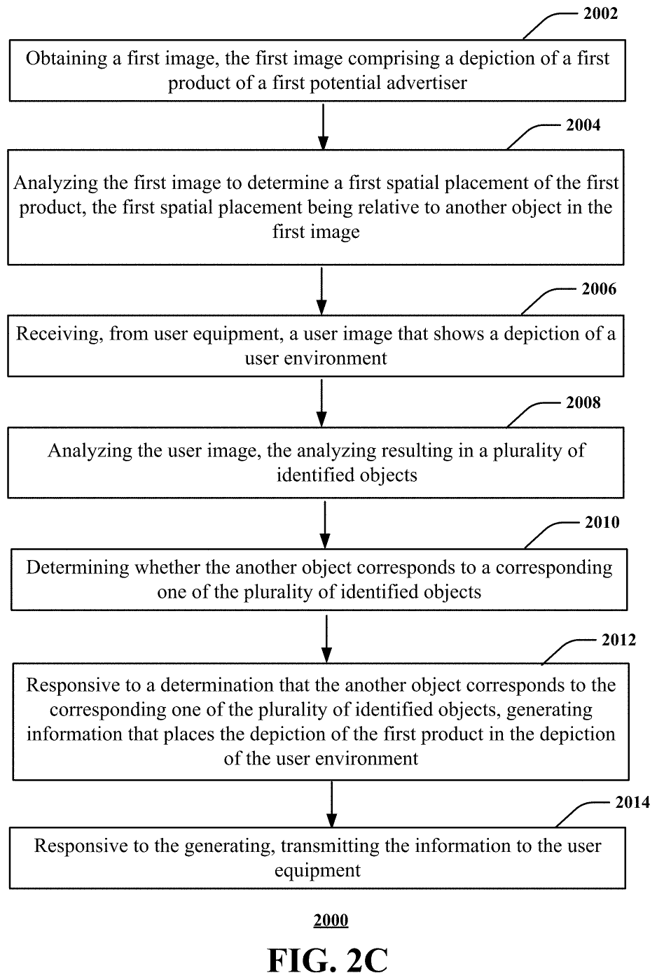

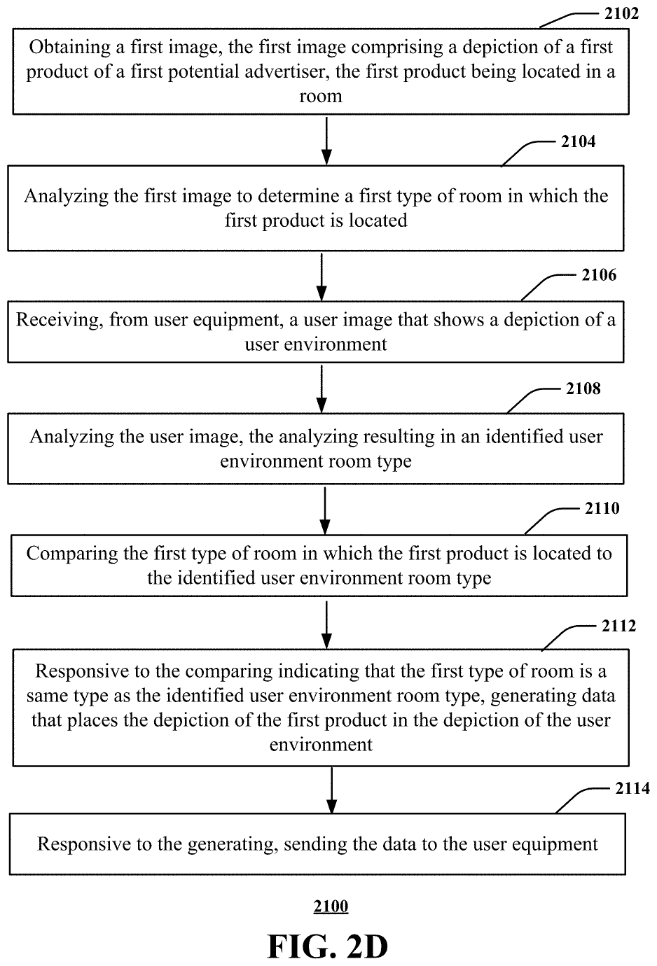

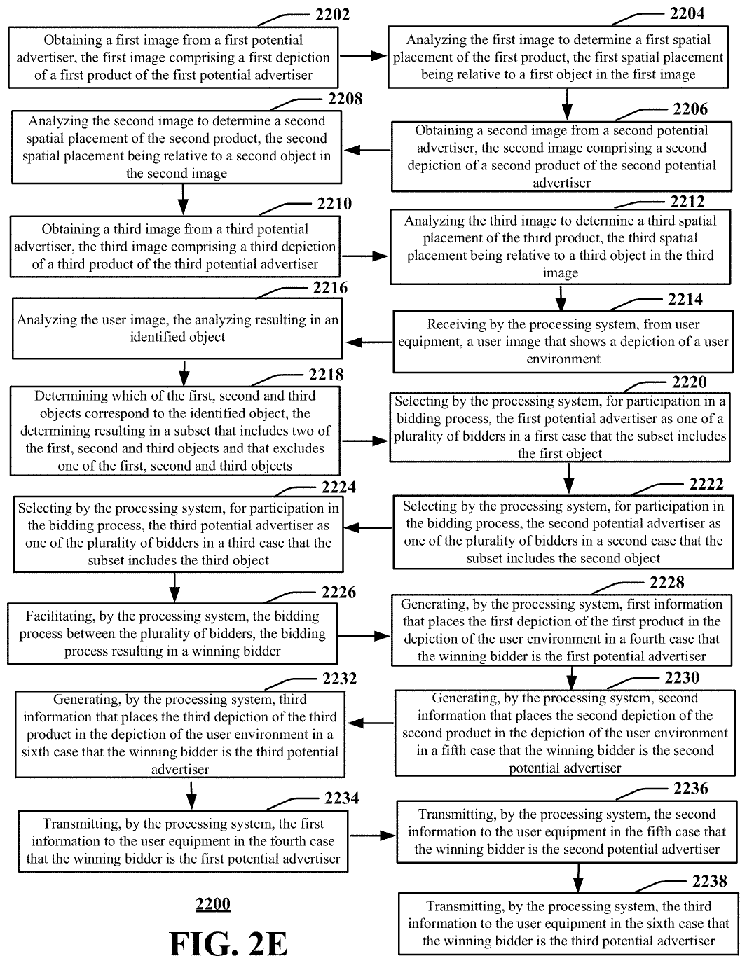

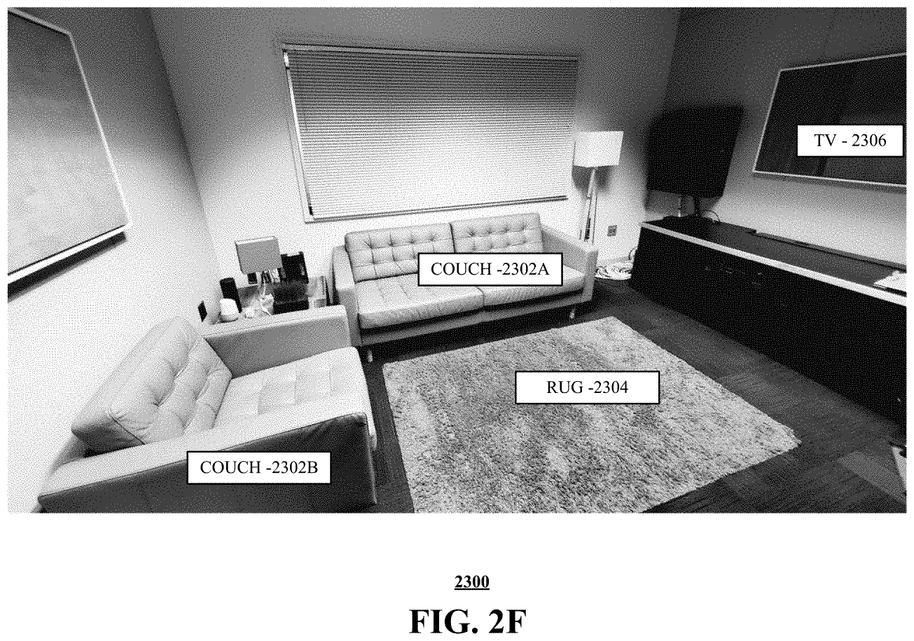

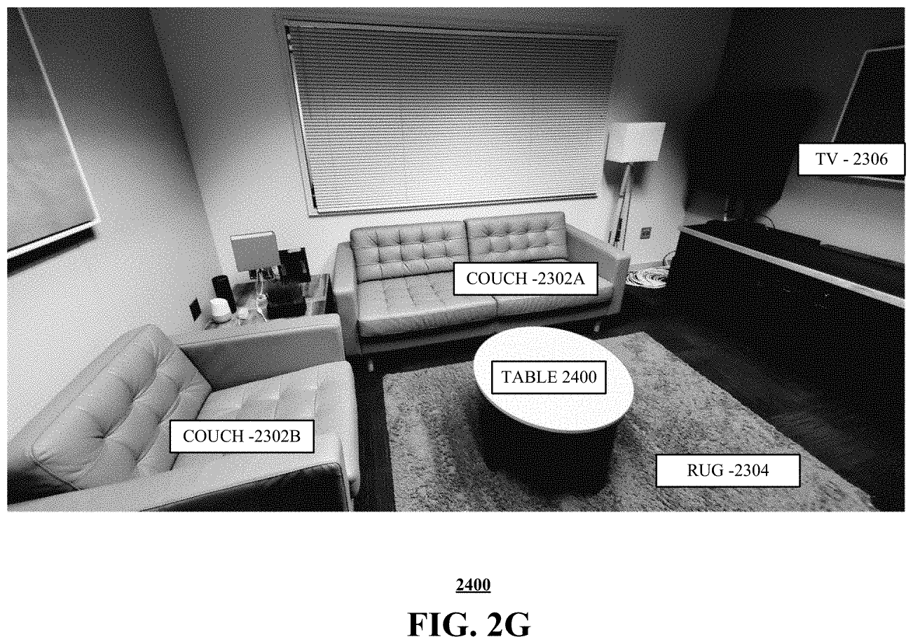

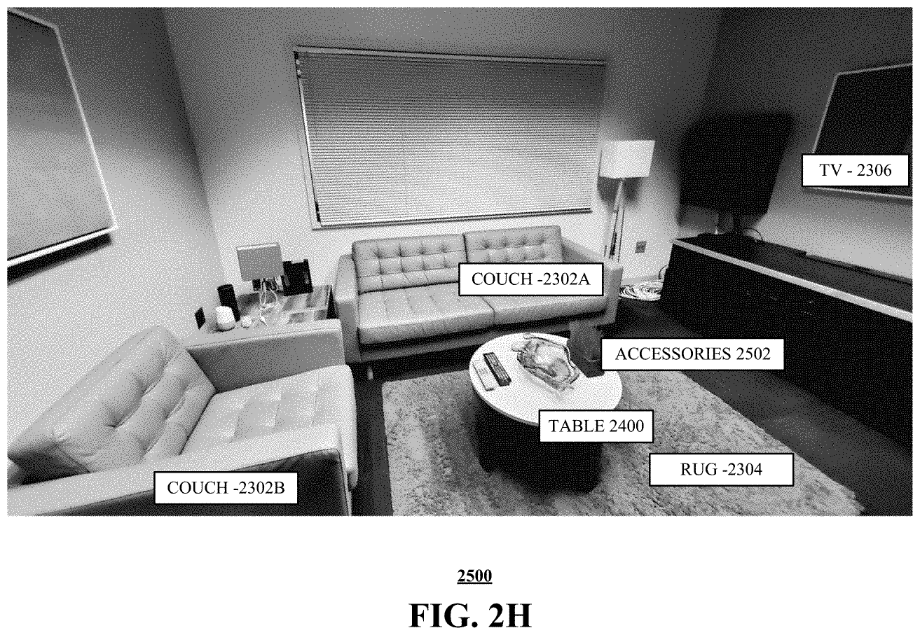

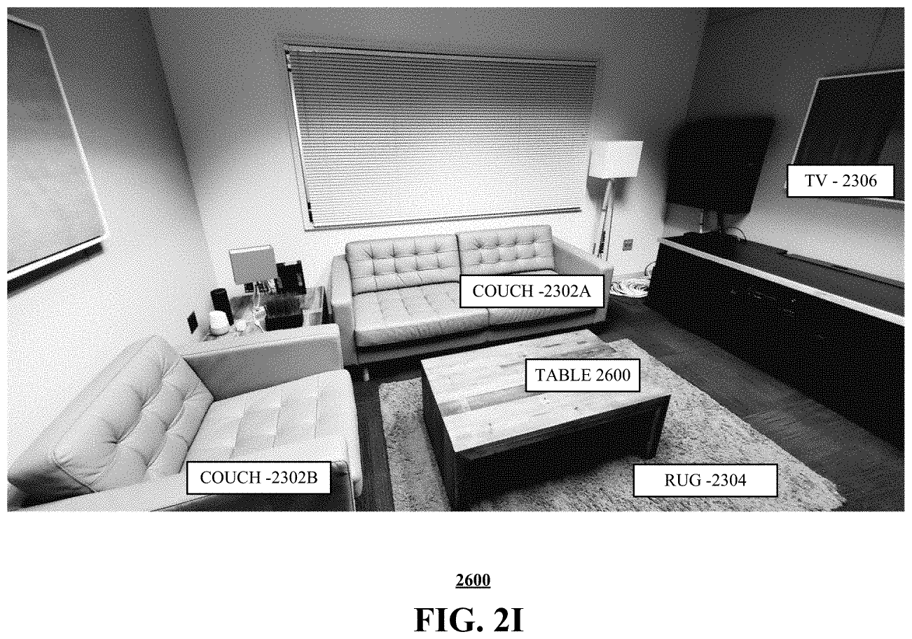

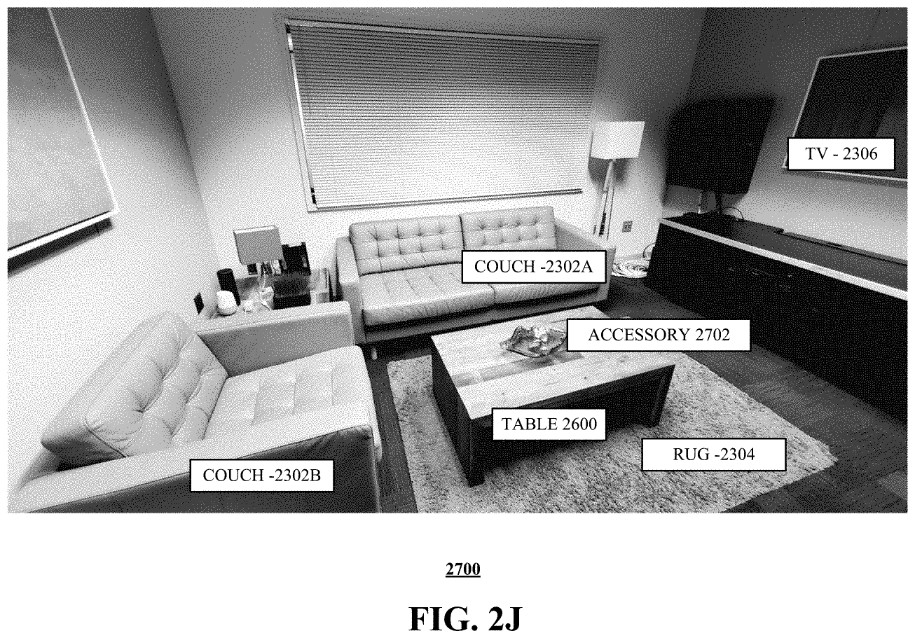

Referring now to FIG. 2A, this is a block diagram illustrating an example, non-limiting embodiment of a system 200 that can function (fully or partially) within the communication network of FIG. 1 in accordance with various aspects described herein.

As seen in this FIG. 2A, this example depicts three users (User 1—204A; User 2—204B; User N—204C). Of course, the three users depicted are examples only, and any desired number of users may utilize the system as described herein. In one specific example: User 1—204A uses a computer (e.g., desktop computer or laptop computer) to engage in bi-directional communication (via Internet 202) with Server System 206; User 2—204B uses a tablet to engage in bi-directional communication (via Internet 202) with Server System 206; and User 3—204C uses a smartphone to engage in bi-directional communication (via Internet 202) with Server System 206.

Still referring to FIG. 2A, this example depicts three advertisers (Advertiser 1—208A; Advertiser 2—208B; Advertiser N—208C). Of course, the three advertisers depicted are examples only, and any desired number of advertisers may utilize the system as described herein. In one specific example: Advertiser 1—208A uses a computer (e.g., a server) to engage in bi-directional communication (via Internet 202) with Server System 206; Advertiser 2—208B uses a computer (e.g., a server) to engage in bi-directional communication (via Internet 202) with Server System 206; and Advertiser 3—208C uses a computer (e.g., a server) to engage in bi-directional communication (via Internet 202) with Server System 206.

Still referring to FIG. 2A, this example depicts Server System 206. This Server System 206 can operate to provide various functionality as described herein (e.g., to receive images from users; to access advertiser catalogs, to make suggestions and/or recommendations and/or advertising placements; to provide suggestions and/or recommendations and/or advertising placements to the users; to facilitate bidding by the advertisers; to facilitate billing to the advertisers (such as for product placements). In one specific example, Server System 206 can provide the functionality of Orchestrator 258 and/or of Recommendation System 260 of FIG. 2B (discussed below).

Referring now to FIG. 2B, this is a block diagram illustrating an example, non-limiting embodiment of a system 250 that can function (fully or partially) within the communication network of FIG. 1 in accordance with various aspects described herein.

As seen in this FIG. 2B, system 250 can include Orchestrator 258 and Recommendation System 260. Advertiser 262 can be in bi-directional communication (via appropriate computers/communication equipment) with Recommendation System 260. A Person 252 (such as a user, customer, prior purchaser, or potential purchaser) is located in a Physical Environment 254. Further, Person 252 uses a computer, tablet, smartphone, or the like to bi-directionally communicate with Orchestrator 258 (such as via Visual Display 256).

Still referring to FIG. 2B, an example operation of system 250 will now be described. Recommendation System 260 can receive from Advertiser 262 a catalog (see arrow 270A). In one example, the catalog is an electronic catalog of products available from the Advertiser 262. Of course, while one advertiser is shown in this example, any desired number of catalogs (or the like) can be uploaded from any desired number of advertisers. In one example, the catalogs (or the like) can be stored in a database. Further, Orchestrator 258 can receive information from Recommendation System 260 regarding co-occurrence placement of objects (see arrow 270B) and object identification can be saved (see arrow 270D—shown in this example as an optional dashed line) to an object/environment patterns database (see database 280A). In one example, the saving of object identification (see, arrow 270D) can be responsive to passive image submission (see, arrow 270C—shown in this example as an optional dashed line).

Still referring to FIG. 2B and the example operation, ranking and bid solicitation can be carried out between Recommendation System 260 and Advertiser 262 (see arrow 270E).

Still referring to FIG. 2B and the example operation, preference expression can be sent from Person 252 to Orchestrator 258 (see arrow 270F). Information regarding this preference expression can be saved in a profiles database (see database 280B).

Still referring to FIG. 2B and the example operation, content/augmented reality data (such as showing the user's physical environment) can be sent to Orchestrator 258 (see arrow 270G). Further, object identification can be saved (see arrow 270H—shown in this example as an optional dashed line) to the object/environment patterns database (see database 280A).

Still referring to FIG. 2B and the example operation, object and content suggestion can be sent to Orchestrator 258 (see arrow 270I). Further, based on this object and content suggestion, the Orchestrator can send to Visual Display (of the user) co-occurrence placement of objects with the scene (see arrow 270J). Further still, based on this co-occurrence placement of objects with the scene, object rendering can be provided to the user (see arrow 270K).

Still referring to FIG. 2B and the example operation, Person 252 can interact with/consume information (see arrow 270L). In one example, this interact with/consume information can comprise image and/or augmented reality viewing by the user (which may, for example, result in one or more online purchases). Further, Person 252 can provide feedback to the Orchestrator 258 (see arrow 270M). In one example, this feedback can be directed to the appropriateness/usefulness of the recommended product(s) to the user.

Still referring to FIG. 2B and the example operation, data regarding user interactions (e.g. touch, usage, dismissal) and content (e.g. video, audio, text) consumption (see arrow 270L) and/or data regarding the feedback (see arrow 270M) can be saved in the profiles database (see database 280B). Further, data regarding user interactions and content consumption (see arrow 270L) and/or data regarding the feedback (see arrow 270M) can be sent to Recommendation System 260 (see arrow 270N—shown in this example as an optional dashed line). Further still, data regarding completion (e.g. user engagement, inspection of an object, subsequent purchases) and context suggestion (e.g. matching a “living room” environment to a bookshelf) can be sent to Advertiser 262 (see arrow 2700—shown in this example as an optional dashed line).

Reference will now be made to an additional discussion of operation of a system according to an embodiment. In this embodiment, a recommendation system (see, e.g., Recommendation System 260 of FIG. 2B) is organized with a catalog. The catalog can be ingested (see, e.g., arrow 270A of FIG. 2B) from an existing database with certain features or pushed by production. Further, system learned co-occurrence of objects (e.g. placement adjacent, angles versus wall, etc.) for object/category (see, e.g., arrow 270B and Orchestrator 258 of FIG. 2B) can be performed. Further still, object id and placement can be saved to database for object patterns (see, e.g., arrow 270D and database 280A of FIG. 2B).

Still referring to the additional discussion of the operation of the system according to an embodiment, a user can submit (see, e.g., arrow 270G of FIG. 2B) one or more photos of their space or of target to place objects. The system can identify objects and query database for recommendations (see, e.g., arrow 270H of FIG. 2B). The advertiser (see, e.g., Advertiser 262 of FIG. 2B) can user spatial ad words to bid (see, e.g., arrow 270E of FIG. 2B) for placement over others in same category (e.g. small room, next to baseball bat, etc.). In one specific example, affinity of similar objects (e.g., those that aren't fixed, like recommendation of baseball bat near other sports clothing that is on the couch) can be optionally used.

Still referring to the additional discussion of the operation of the system according to an embodiment, user interest in specific items can be determined (e.g., determined explicitly and/or inferred). In one example, the user specifies specific object of interest. In another example, user interest is determined (optionally) by passive gaze and/or linger/interest detection (e.g., how long dwelled) to filter/exclude/include particular objects.

Still referring to the additional discussion of the operation of the system according to an embodiment, a “post-mortem” task can be performed for data/model improvement. In one example, feedback (see, e.g., arrow 270M of FIG. 2B) from user (implicit and/or explicit) for purchase action and recommendation approval can be provided. In another example, the feedback can be associated with a user profile (see, e.g., database 280B of FIG. 2B), augmented by new purchase and recent preference expression. In another example, a marketplace for interest and observations for particular “spatial ad words” that can be purchased/acted upon by ad-buyers can be provided. In another example, there can be inclusions for user preferences to filter (e.g. local construction, color preference, etc.) merchandise that the recommendation system permits. In another example, models for object context (position and style) can updated.

Referring now to FIG. 2C, various steps of a method 2000 according to an embodiment are shown. As seen in this FIG. 2C, step 2002 comprises obtaining a first image (such as, for example, from a catalog), the first image comprising a depiction of a first product (e.g., a coffee table) of a first potential advertiser. Next, step 2004 comprises analyzing the first image to determine a first spatial placement of the first product, the first spatial placement being relative to another object in the first image (e.g., in the catalog a couch is shown next to the coffee table that will potentially be advertised). Next, step 2006 comprises receiving, from user equipment, a user image that shows a depiction of a user environment (e.g., a room in the user's house). Next, step 2008 comprises analyzing the user image, the analyzing resulting in a plurality of identified objects (e.g., a couch and a TV stand). Next, step 2010 comprises determining whether the another object (the couch in the catalog image) corresponds to a corresponding one (the user's couch) of the plurality of identified objects. Next, step 2012 comprises responsive to a determination that the another object (the coffee table in the catalog image) corresponds to the corresponding one (the user's couch) of the plurality of identified objects, generating information that places the depiction of the first product (the coffee table from the catalog) in the depiction of the user environment (the user's room). Next, step 2014 comprises responsive to the generating, transmitting the information to the user equipment (the information that is transmitted can be, for example, an image of the coffee table from the catalog placed in the image of the user's room; in another example, the information that is transmitted can be data and/or instructions which allow the user equipment to render an image of the coffee table from the catalog placed in the image of the user's room).

In one example, the generating the information can comprise placing the depiction of the first product at a target spatial location in the depiction of the user environment, the target spatial location being selected such that the target spatial location for the depiction of the first product is relative to the corresponding one of the plurality of identified objects in substantially a same manner that the first spatial placement of the first product is relative to the another object in the first image. In various examples, the spatial location for the depiction of the first product can indicate on, around, near-by, encompassing, within, obscuring, attaching (e.g., attaching to an object). In various other examples, the spatial location for the depiction of the first product can indicate attached to a secondary object (e.g., a wall, a table surface) and/or near some other object. In another example, a surface where an object (e.g., a depiction of a product) would be located can be computed via vision (e.g., the coordinates of the surface selected could be calculated to understand the relationship of the physical dimension of some other (e.g., adjacent) object for representation). In another example, selecting a position for an object (e.g., a depiction of a product) could be accomplished by placing a highlight of a base of the object, where normal gravity rules apply, and placing that base in the correct position either manually by the user or by a third party, or automatically by computer estimation.

In one example, the same type of object can mean two objects, both being tables. In another example, the same type of object can mean two objects, both being chairs. In another example, the same type of object can mean two objects, both being floor coverings. In another example, the same type of object can mean two objects, both being furniture. In another example, the same type of object can mean two objects, both being beds. In another example, the same type of object can mean two objects, both being baths. In another example, the same type of object can mean two objects, both being toilets. In another example, the same type of object can mean two objects, both being pillows. In another example, the same type of object can mean two objects, both being décor. In another example, the same type of object can mean two objects, both being storage. In another example, the same type of object can mean two objects, both being lights. In another example, the same type of object can mean two objects, both being cabinets. In another example, the same type of object can mean two objects, both being appliances.

While for purposes of simplicity of explanation, the respective processes are shown and described as a series of blocks in FIG. 2C, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIGS. 2F-2J, depicted are example, non-limiting embodiments showing illustrations of placement of objects in images of a room in accordance with various aspects described herein. As shown in FIG. 2F, a user can be in a room and viewing an image 2300 (such as via augmented reality) of the room. In this depiction, the room includes Couch 2302A, Couch 2302B, Rug 2304 and TV 2306. This FIG. 2F can be thought of in this example as a “before” image. Using various mechanisms described herein, the user can then be presented (such as via augmented reality) with the image 2400 (see FIG. 2G). As seen in FIG. 2G, Table 2400 (which can be, for example, a product advertised by an advertiser) is added to image 2400. Further, using various mechanisms described herein, the user can then be presented (such as via augmented reality) with the image 2500 (see FIG. 211). As seen in FIG. 211, one or more Accessories 2502 (which can be, for example, products advertised by an advertiser) are further added to image 2500. In another example, (see FIG. 21) the “before” image can have added to it (using various mechanisms described herein) a different style of table (Table 2600). In this example, Table 2600 can be another product advertised by an advertiser. The user can be presented (such as via augmented reality) with the image 2600. As seen in FIG. 2J, an Accessory 2702 (which can be, for example, a product advertised by an advertiser) is added (using various mechanisms described herein) to image 2700 (which can be presented to the user such as via augmented reality).

Referring now to FIG. 2D, various steps of a method 2100 according to an embodiment are shown. As seen in this FIG. 2D, step 2102 comprises obtaining a first image (such as, for example, from a catalog), the first image comprising a depiction of a first product (e.g., a bedroom dresser) of a first potential advertiser, the first product being located in a room (e.g., a bedroom). Next, step 2104 comprises analyzing the first image to determine a first type of room (in this example, a bedroom) in which the first product (the bedroom dresser from the catalog) is located. Next, step 2106 comprises receiving, from user equipment, a user image that shows a depiction of a user environment (e.g., the user's bedroom). Next, step 2108 comprises analyzing the user image, the analyzing resulting in an identified user environment room type (in this example, a bedroom). Next, step 2110 comprises comparing the first type of room in which the first product is located (in this example, a bedroom) to the identified user environment room type (in this example, a bedroom). Next, step 2112 comprises responsive to the comparing indicating that the first type of room is a same type as the identified user environment room type, generating data that places the depiction of the first product (the bedroom dresser from the catalog) in the depiction of the user environment (the user's bedroom). Next, step 2114 comprises responsive to the generating, sending the data to the user equipment (the data that is sent to the user equipment can be, for example, a combined image including an image of the bedroom dresser from the catalog placed in the image of the user's bedroom; in another example, the data that is sent to the user equipment can include instructions which enable the user equipment to render a combined image including an image of the bedroom dresser from the catalog placed in the image of the user's bedroom).

In one example, the same type of room can mean instead a location, such as a POS work stand, a desk, a yard, a porch, a driveway.

While for purposes of simplicity of explanation, the respective processes are shown and described as a series of blocks in FIG. 2D, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2E, various steps of a method 2200 according to an embodiment are shown. As seen in this FIG. 2E, step 2202 comprises obtaining a first image (such as, for example, from a first catalog) from a first potential advertiser, the first image comprising a first depiction of a first product (e.g., a first nightstand) of the first potential advertiser. Next, step 2204 comprises analyzing the first image to determine a first spatial placement of the first product, the first spatial placement being relative to a first object in the first image (e.g., in the first catalog a first bed is shown next to the first nightstand that will potentially be advertised). Next, step 2206 comprises obtaining a second image (such as, for example, from a second catalog) from a second potential advertiser, the second image comprising a second depiction of a second product (e.g., a second nightstand) of the second potential advertiser. Next, step 2208 comprises analyzing the second image to determine a second spatial placement of the second product, the second spatial placement being relative to a second object in the second image (e.g., in the second catalog a second bed is shown next to the second nightstand that will potentially be advertised). Next, step 2210 comprises obtaining a third image (such as, for example, from a third catalog) from a third potential advertiser, the third image comprising a third depiction of a third product (e.g., a dining room table) of the third potential advertiser. Next, step 2212 comprises analyzing the third image to determine a third spatial placement of the third product, the third spatial placement being relative to a third object in the third image (e.g., in the third catalog a dining room chair is shown next to dining room table that will potentially be advertised). Next, step 2214 comprises receiving by the processing system, from user equipment, a user image that shows a depiction of a user environment (e.g., a room in the user's house). Next, step 2216 comprises analyzing the user image, the analyzing resulting in an identified object (e.g., a bed). Next, step 2218 comprises determining which of the first, second and third objects correspond to the identified object (a bed), the determining resulting in a subset that includes two of the first, second and third objects (in this example, the first and second beds) and that excludes one of the first, second and third objects (in this case the dining room chair). Next, step 2220 comprises selecting by the processing system, for participation in a bidding process, the first potential advertiser as one of a plurality of bidders in a first case that the subset includes the first object. Next, step 2222 comprises selecting by the processing system, for participation in the bidding process, the second potential advertiser as one of the plurality of bidders in a second case that the subset includes the second object. Next, step 2224 comprises selecting by the processing system, for participation in the bidding process, the third potential advertiser as one of the plurality of bidders in a third case that the subset includes the third object. Next, step 2226 comprises facilitating, by the processing system, the bidding process between the plurality of bidders, the bidding process resulting in a winning bidder (such as a high bidder). Next, step 2228 comprises generating, by the processing system, first information that places the first depiction of the first product in the depiction of the user environment in a fourth case that the winning bidder is the first potential advertiser. Next, step 2230 comprises generating, by the processing system, second information that places the second depiction of the second product in the depiction of the user environment in a fifth case that the winning bidder is the second potential advertiser. Next, step 2232 comprises generating, by the processing system, third information that places the third depiction of the third product in the depiction of the user environment in a sixth case that the winning bidder is the third potential advertiser. Next, step 2234 comprises transmitting, by the processing system, the first information to the user equipment in the fourth case that the winning bidder is the first potential advertiser. Next, step 2236 comprises transmitting, by the processing system, the second information to the user equipment in the fifth case that the winning bidder is the second potential advertiser. Next, step 2238 comprises transmitting, by the processing system, the third information to the user equipment in the sixth case that the winning bidder is the third potential advertiser.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

As described herein, various embodiments can provide for “spatial ad words” (e.g., as a way for advertiser to express rules and preference for placement of objects in augmented reality or simulated scenarios).

As described herein, various embodiments can provide personalization by detection of user objects (e.g., scanning a user's room or input picture to understand existing style and objects present in the captured content for reuse or suggestion with others).

As described herein, various embodiments can provide for recommendation of catalog items from contextual product features (e.g., by understanding user parameters from existing product, find other products that have similar properties (e.g., size of the bookshelf determines size of the TV stand that may accompany it).

As described herein, various embodiments can provide for using spatial co-occurrence from user data as well as catalog(s), to provide automated suggestions/recommendations for placement and orientation of the target objects in one-shot scenarios (e.g., as if placed by professional designer instead of user drag-drop in certain existing AR mechanisms).

As described herein, various embodiments can be utilized in the context of image(s) and/or augmented reality.

As described herein, various embodiments can provide for object placement manipulation. In one example: know where to put similar object, use historical placement of objects in 3D space; can be fed by 3D model baseline (e.g., from structural or architectural planning that are ingested/available by other sources). In another example: use affinity of similar objects (e.g., those that aren't fixed, like recommendation of baseball bat near other sports clothing that is on the couch). In another example: gaze and linger/interest detection to filter and/or exclude and/or include particular objects; marketplace for interest and observations for particular “spatial ad words” that can be purchased/acted upon by ad-buyers; have inclusions for user preferences to filter (e.g. local construction, color preference, etc.).

As described herein, various embodiments can be utilized for online merchandising in the context of visualization by augmented reality applications and/or in the context of visualization from one or more image samples provided by a user (e.g., a potential purchaser). Various embodiments can facilitate the providing of one or more suggested items that is an appropriate fit for a given purchaser's style, preferences, available space, etc.

As described herein, various embodiments can be utilized to provide an advertiser (e.g., an advertiser of a product which will have a simulated product placement in an image presented to a user) a mechanism to specify one or more restrictions regarding one or more environments (e.g., do not allow product placement for this given advertiser of a given product in a media room or in a sports scenario).

As described herein, various embodiments can be utilized to provide an advertiser (e.g., an advertiser of a product which will have a simulated product placement in an image presented to a user) a mechanism to specify one or more affinities regarding one or more environments (e.g., allow product placement for this given advertiser of a given product only in a matching media room or only in a sports scenario).

As described herein, various embodiments can be utilized to provide: (a) more accurate recommendations for product placement based on what a customer is viewing and/or based on their personal environment (e.g., instead of textual and/or historical restrictions alone); (b) lower cost and churn likelihood for product purchases (e.g., fewer returns) with more realistic placement and closer to user preferences; (c) no (or reduced) buyer's remorse because the purchase was already style-matched; (d) higher customer satisfaction because their user experience is improved with automated system (e.g., with augmented reality and/or image-based suggestion); and/or (e) new opportunities for deeply promoting content from a catalog (e.g., match obscure product from a historical archive according to style).

As described herein, various embodiments can provide page (webpage) rendering for a product on one or more commerce sites (e.g., eCommerce websites). Such webpage rendering can be dynamic and/or can be based on one or more user preferences.

As described herein, various embodiments can provide content positioning (e.g., content blocks, design elements) that can be dynamically moved around (e.g., dynamically moved around a webpage) based on need. With respect to such dynamic movements, various embodiments can apply learning (e.g., to make suggestions/provide simulated product placements for a current user and/or to make suggestions/provide simulated product placements for the same user (and/or one or more other users) at a later time) based on “time gazed” (e.g., number of seconds that a user's gaze is directed to a particular location or a particular object in an image). With respect to such dynamic movements, various embodiments can apply learning (e.g., to make suggestions/provide simulated product placements for a current user and/or to make suggestions/provide simulated product placements for the same user (and/or one or more other users) at a later time) based on a user's scope with respect to a browser (e.g. a desktop, phone, AR application, audio-only experience, etc.). With respect to such dynamic movements, various embodiments can determine which attributes stand out most to people (e.g., size of item, wattage, etc.), wherein certain details can move based on the user's needs. With respect to such dynamic movements, various embodiments can contextualize where the information (and/or simulated product placement) goes. For example, various embodiments can contextualize based on comparisons by product features from different platforms, such as a mobile AR application, a commerce-based web page, or a home remodeling application. Respectively, each of these platforms may cater to a different context of the same user such as curious exploration of new products, accessorizing against an existing room, or redesigning a space. With respect to such dynamic movements, various embodiments can scale and/or resize content based on the demographic of user. For example, elderly individuals who need larger content sizing, or who might care about fewer details.

As described herein, various embodiments can facilitate ranking and/or selling in commerce sites (e.g., eCommerce websites). In one example, adwords can be chosen based on the specific word. In another example, advertisers can buy “ranks” or “positions” for keywords (e.g., top keywords of a previously ran (advertised) item). This can allow advertisers (e.g., at websites) to bid for a specific position regardless of the words. For instance, advertiser “A” might buy a “silver level” positioning, which provides for specific words that have specific levels of effectiveness, and/or determines the number of words that advertiser “A” gets, and/or determines the variety of statements that advertiser “A” gets. These statements, which can be automatically generated or written by human curators, can be more calm or generic (e.g. “this interesting lamp”) versus those keywords from a higher tier of positioning (e.g. “this sterling silver lamp complements modern features in this room”). In another example, in a video, an advertiser can advertise on individual frame(s) and/or can grab a specific moment. In one specific example, a mechanism can be provided to override adword ranking (e.g., vendor: “when people are looking at brightness of lightbulbs, I want to always be top ranked for a recommendation”). In another example, imagery can be included (e.g., specific imagery that matches the specified topical adwords that a user might be seeking) to add personalization (e.g., specific team branding to complement a sports-oriented product) to the visualization.

As described herein, various embodiments can provide mechanisms to: (a) transform from image input and personal description into commence opportunities (e.g., who I want to be, how I want to represent myself); (b) facilitate input that can be visual (e.g., augmented reality); (c) facilitate specifying different limits by interest (e.g., placement, objects, keywords, etc.); (d) facilitate a “virtual designer” for space and style alignment; recommendations and keywords for user to activate (modulate) like “will make space bigger”; and/or (e) allow different styles to be applied (e.g., modern, excited, holiday).

As described herein, various embodiments can be applied in the context of home and/or business and/or/warehouse.

As described herein, various embodiments can provide for photo-realistic object placement (e.g., image seam filling to move and/or delete one or more obscuring visuals in the source image to allow full display of the target object, etc.) to allow rearrangement.

As described herein, various embodiments can utilize inventory reports from other content (e.g., the scene and setting from a particular popular show); such reports can be associated to a given user's current image/viewing based on a code, augmentation, user query, suggestion etc.

As described herein, advertisers can buy positioning (e.g., advertisement should only be shown with high-end items (e.g., high-end pillow/bed)).

As described herein, various embodiments can virtualize existing objects in a room to allow interactive editing of both current items (e.g. chairs) as well as newly purchased items (e.g., new table or stand).

As described herein, various embodiments can be utilized for placement of network equipment for customer install (e.g., where to put a STB/receiver and modem); if alternate styles are available, select those items that are better aligned a given user's environment).

As described herein, various embodiments can be used for personal fashion evaluation (e.g., improvement for personal style and mirror simulation) while allowing spatial ad words and matching of user preference(s).

As described herein, various embodiments can provide “reverse” projection (e.g., wherein the system knows of a user's home and the home information (e.g., image(s)) can be submitted for projection onto other displays in physical stores (e.g., walk to retail store “A” and put your room in the showroom)).

As described herein, various embodiments can provide a “virtual designer” for space and style alignment (e.g., recommendations and keywords for user to activate (modulate) like “will make space bigger”).

As described herein, various embodiments provide for dynamic page (webpage) configurations including image size, placement, and attribute selection.

As described herein, various embodiments enable style matching for objects to sell (e.g., via use of computer vision and/or search).

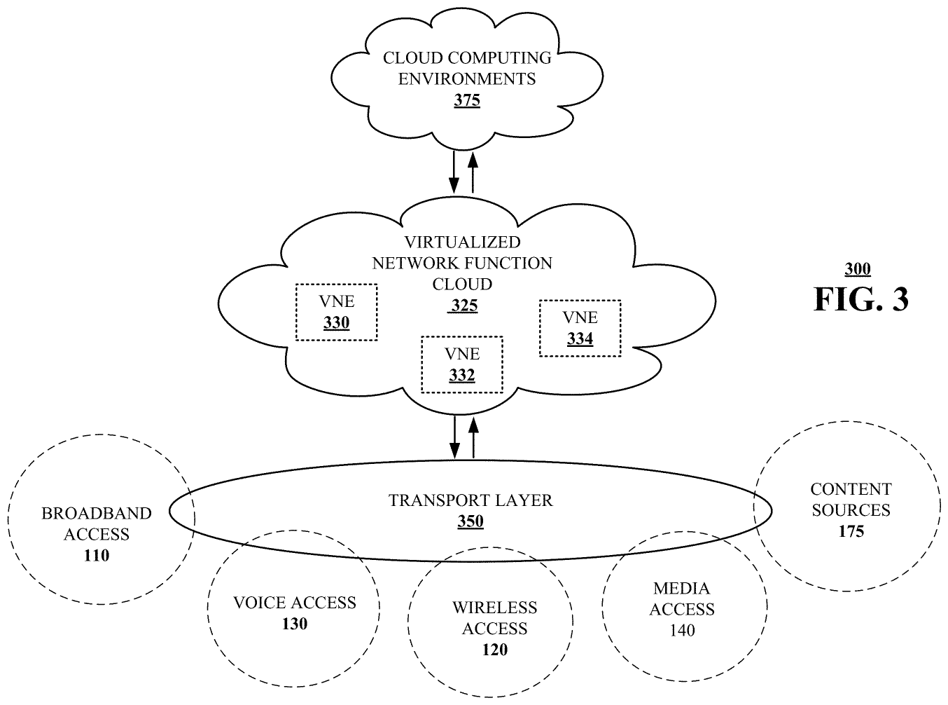

Referring now to FIG. 3, a block diagram 300 is shown illustrating an example, non-limiting embodiment of a virtualized communication network in accordance with various aspects described herein. In particular a virtualized communication network is presented that can be used to implement some or all of the subsystems and functions of communication network 100, some or all of the subsystems and functions of system 200, some or all of the subsystems and functions of system 250, and/or all or parts of each of methods 2000, 2100 and 2200 presented in FIGS. 1, 2A, 2B, 2C, 2D and 2E. For example, virtualized communication network 300 can facilitate in whole or in part merchandising, product selection, location selection for image placement, and/or advertiser selection as described herein. In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

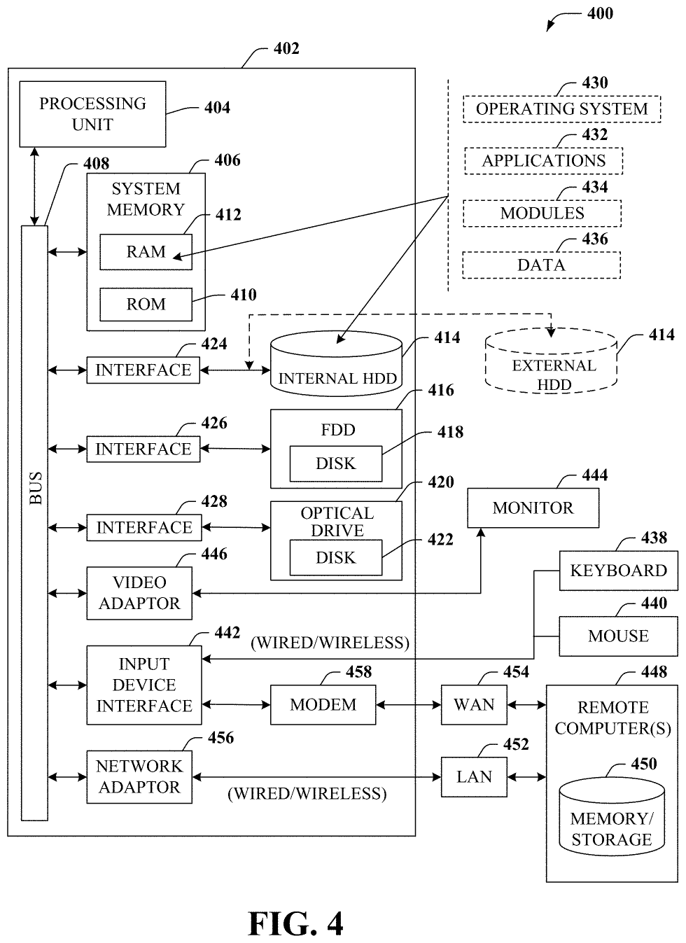

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part merchandising, product selection, location selection for image placement, and/or advertiser selection as described herein.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

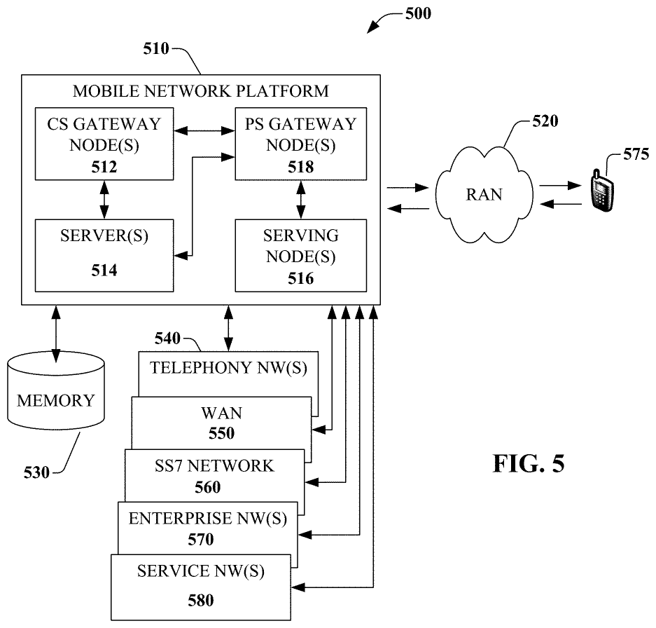

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part merchandising, product selection, location selection for image placement, and/or advertiser selection as described herein. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

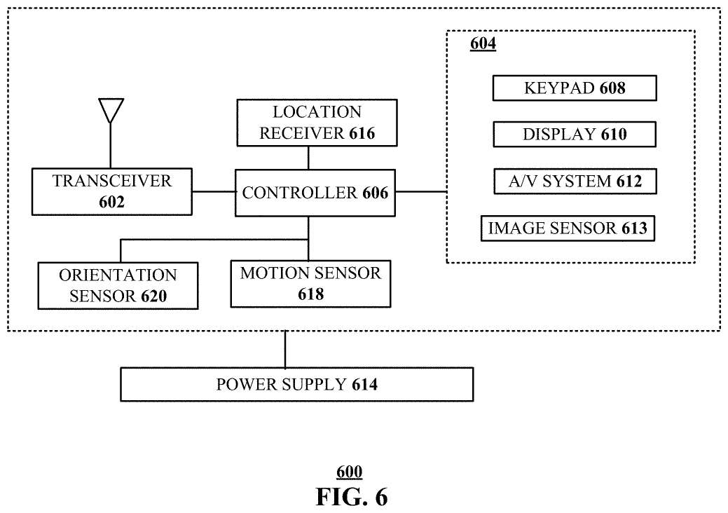

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part merchandising, product selection, location selection for image placement, and/or advertiser selection as described herein.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically providing merchandising, product selection, location selection for image placement, and/or advertiser selection as described herein) can employ various AI-based schemes for carrying out various embodiments thereof. Moreover, the classifier can be employed to determine a ranking or priority of various selections. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria various merchandising, product selection, location selection for image placement, and/or advertiser selection aspects as described herein.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
obtaining a first image, the first image comprising a depiction of a first product of a first potential advertiser;
analyzing the first image to determine a first spatial placement of the first product, the first spatial placement being relative to another object in the first image;
receiving, from user equipment, a user image that shows a depiction of a user environment;
analyzing the user image, the analyzing resulting in a plurality of identified objects;
determining whether the another object corresponds to a corresponding one of the plurality of identified objects;
responsive to a determination that the another object corresponds to the corresponding one of the plurality of identified objects, generating information that places the depiction of the first product in the depiction of the user environment; and
responsive to the generating, transmitting the information to the user equipment.

2. The device of claim 1, wherein the determining whether the another object corresponds to a corresponding one of the plurality of identified objects comprises determining that the another object and the corresponding one of the plurality of identified objects are both a same type of object.

3. The device of claim 2, wherein the same type of object comprises one of a chair, a sofa, a couch, a side table, a coffee table, a desk, a dining room table, a kitchen table, a TV stand, a bed, a nightstand, a bookcase, a mobile phone, a television, a smart watch, a tablet, a virtual reality headset, a mirror, a window, or a door.

4. The device of claim 1, wherein the generating the information comprises placing the depiction of the first product at a target spatial location in the depiction of the user environment, the target spatial location being selected such that the target spatial location for the depiction of the first product is relative to the corresponding one of the plurality of identified objects in substantially a same manner that the first spatial placement of the first product is relative to the another object in the first image.

5. The device of claim 1, wherein the obtaining comprises receiving the first image from the first potential advertiser.

6. The device of claim 1, wherein:
the user image comprises a single image, a plurality of images, a video stream, or any combination thereof; and
the user equipment comprises a camera, a webcam, an augmented reality application, a virtual reality application, a head-mounted device, an eyeglasses device, a projector, or any combination thereof.

7. The device of claim 1, wherein:
the information that is transmitted to the user equipment comprises data that facilitates presenting to the user, by the user equipment, the depiction of the first product in the depiction of the user environment; and
the user equipment comprises a web browser, an augmented reality application, a virtual reality application, a head-mounted device, an eyeglasses device, or any combination thereof.

8. The device of claim 1, wherein:
the information that is transmitted to the user equipment comprises a single image, a plurality of images, a video stream, or any combination thereof; and
the user equipment comprises a web browser, an augmented reality application, a virtual reality application, a head-mounted device, an eyeglasses device, or any combination thereof.

9. The device of claim 1, wherein the obtaining the first image comprises obtaining the first image from a database in which the first image is stored.

10. The device of claim 1, wherein the operations further comprise receiving the first image from the first potential advertiser.

11. The device of claim 1, wherein the transmitting the information to the user equipment causes the first potential advertiser to become an actual advertiser.

12. The device of claim 11, wherein the operations further comprise billing the actual advertiser for placement of the depiction of the first product.

13. The device of claim 1, wherein the operations further comprise:
obtaining a second image, the second image comprising a depiction of a second product of a second potential advertiser;
analyzing the second image to determine a second spatial placement of the second product, the second spatial placement being relative to a second object in the second image;
receiving, from other user equipment, another user image that shows a depiction of another user environment, a second user of the other user equipment being different from a first user of the user equipment;
analyzing the another user image, the analyzing of the another user image resulting in another plurality of identified objects;
determining whether the second object corresponds to a another corresponding one of the another plurality of identified objects;
responsive to a another determination that the second object corresponds to the another corresponding one of the another plurality of identified objects, generating other information that places the depiction of the second product in the depiction of the other user environment; and
responsive to the generating the other information, transmitting the other information to the other user equipment;
wherein the transmitting the other information to the other user equipment causes the second potential advertiser to become another actual advertiser; and
wherein the operations further comprise billing the another actual advertiser for placement of the depiction of the second product.

14. A machine-readable medium comprising executable instructions that, when executed by a processing system including a processor, facilitate performance of operations, the operations comprising:
obtaining a first image, the first image comprising a depiction of a first product of a first potential advertiser, the first product being located in a room;
analyzing the first image to determine a first type of room in which the first product is located;
receiving, from user equipment, a user image that shows a depiction of a user environment;
analyzing the user image, the analyzing resulting in an identified user environment room type;
comparing the first type of room in which the first product is located to the identified user environment room type;
responsive to the comparing indicating that the first type of room is a same type as the identified user environment room type, generating data that places the depiction of the first product in the depiction of the user environment; and
responsive to the generating, sending the data to the user equipment.

15. The machine-readable medium of claim 14, wherein the same type comprises one of a kitchen, a dining room, a bedroom, an office, a study, a den for a family, a playroom for a family, a bedroom for a baby, a bedroom for a child, a bedroom for a teenager, a bedroom for an adult, a personal home theater, a trophy room, a bar, a pub, a bathroom, a cabin, a lodge, a spa, a meditation room, a workplace office, an office cubicle, a garage, a basement, or a cellar.

16. The machine-readable medium of claim 14, wherein:
the data that is sent to the user equipment facilitates presenting to a user of the user equipment, by the user equipment, the depiction of the first product in the depiction of the user environment; and
the user equipment comprises a web browser, an augmented reality application, a virtual reality application, a head-mounted device, an eyeglasses device, or any combination thereof.

17. The machine-readable medium of claim 14, wherein the data that is transmitted to the user equipment comprises a single image, a plurality of images, a video stream, or any combination thereof.

18. A method comprising:
obtaining, by a processing system comprising a processor, a first image from a first potential advertiser, the first image comprising a first depiction of a first product of the first potential advertiser;
analyzing, by the processing system, the first image to determine a first spatial placement of the first product, the first spatial placement being relative to a first object in the first image;
obtaining, by the processing system, a second image from a second potential advertiser, the second image comprising a second depiction of a second product of the second potential advertiser;
analyzing, by the processing system, the second image to determine a second spatial placement of the second product, the second spatial placement being relative to a second object in the second image;
obtaining, by the processing system, a third image from a third potential advertiser, the third image comprising a third depiction of a third product of the third potential advertiser;
analyzing, by the processing system, the third image to determine a third spatial placement of the third product, the third spatial placement being relative to a third object in the third image;
receiving by the processing system, from user equipment, a user image that shows a depiction of a user environment;
analyzing, by the processing system, the user image, the analyzing resulting in an identified object;
determining by the processing system which of the first, second and third objects correspond to the identified object, the determining resulting in a subset that includes two of the first, second and third objects and that excludes one of the first, second and third objects;
selecting by the processing system, for participation in a bidding process, the first potential advertiser as one of a plurality of bidders in a first case that the subset includes the first object;
selecting by the processing system, for participation in the bidding process, the second potential advertiser as one of the plurality of bidders in a second case that the subset includes the second object;
selecting by the processing system, for participation in the bidding process, the third potential advertiser as one of the plurality of bidders in a third case that the subset includes the third object;
facilitating, by the processing system, the bidding process between the plurality of bidders, the bidding process resulting in a winning bidder;
generating, by the processing system, first information that places the first depiction of the first product in the depiction of the user environment in a fourth case that the winning bidder is the first potential advertiser;
generating, by the processing system, second information that places the second depiction of the second product in the depiction of the user environment in a fifth case that the winning bidder is the second potential advertiser;
generating, by the processing system, third information that places the third depiction of the third product in the depiction of the user environment in a sixth case that the winning bidder is the third potential advertiser;
transmitting, by the processing system, the first information to the user equipment in the fourth case that the winning bidder is the first potential advertiser;
transmitting, by the processing system, the second information to the user equipment in the fifth case that the winning bidder is the second potential advertiser; and
transmitting, by the processing system, the third information to the user equipment in the sixth case that the winning bidder is the third potential advertiser.

19. The method of claim 18, wherein the determining which of the first, second and third objects correspond to the identified object comprises:
determining whether the identified object and the first object are both a same type of object, wherein the first object is included in the subset if the identified object and the first object are both the same type of object;
determining whether the identified object and the second object are both the same type of object, wherein the second object is included in the subset if the identified object and the second object are both the same type of object;
determining whether the identified object and the third object are both the same type of object, wherein the third object is included in the subset if the identified object and the third object are both the same type of object;
wherein the same type of object comprises one of a chair, a sofa, a couch, a side table, a coffee table, a desk, a dining room table, a kitchen table, a TV stand, a bed, a nightstand, a bookcase, a mobile phone, a television, a smart watch, a tablet, a virtual reality headset, a mirror, a window, or a door.

20. The method of claim 18, wherein:
the generating the first information comprises placing the first depiction of the first product at a first target spatial location in a depiction of the user environment, the first target spatial location being selected such that the first target spatial location is relative to the identified object in substantially a same manner that the first spatial placement is relative to the first object in the first image;
the generating the second information comprises placing the second depiction of the second product at a second target spatial location in the depiction of the user environment, the second target spatial location being selected such that the second target spatial location is relative to the identified object in substantially a same manner that the second spatial placement is relative to the second object in the second image; and
the generating the third information comprises placing the third depiction of the third product at a third target spatial location in the depiction of the user environment, the third target spatial location being selected such that the third target spatial location is relative to the identified object in substantially a same manner that the third spatial placement is relative to the third object in the third image.
